(19) United States
(12) Patent Application Publication
(10) Pub. No.: US 2018/0345717 A1
(43) Pub. Date: Dec. 6, 2018

(54) Storage Device for a Brush

(71) Applicant: GOLLER APS, Vejen (DK)

(72) Inventor: Per Goller, Vejen (DK)

(21) Appl. No.: 15/776,815

(22) PCT Filed: Nov. 17, 2016
(86) PCT No.: PCT/DK2016/050370

§ 371 Date: May 17, 2018

(30) Foreign Application Priority Data
Nov. 17, 2015 (DK) PA 2015 70740

(51) Int. Cl. B44D 3/12

(52) U.S. Cl. CPC B44D 3/125

(57) ABSTRACT

The invention relates to storage device for a brush, the storage device comprising a flexible plastic container comprising an inside face and an outside face, where the plastic container comprises a tapered area between a first wider end towards a second narrower end and where the tapered area on the inside face has a dimension allowing a fit with one or more sizes of brush heads.

### FIELD OF THE INVENTION

The present invention relates to storage devices for brushes, in particular paint brushes, which have been used and are intended to be used again.

### BACKGROUND OF THE INVENTION

A normal paint brush is used to apply paint onto a surface. Often a paint job is interrupted, either because of the size of the job or because an interfering activity requires the interruption.

Such interruption requires a cleaning of the brush in order to maintain the ability of the brush to apply the paint in an even and controlled manner. The result of neglecting the cleaning process will be hardening or solidification of the paint and after a while it will be impossible to remove the paint, leading to a poor painting quality or even a useless brush. Cleaning of a brush is a time consuming task and in particular annoying when it is known that the same brush is intended to be used for the same paint again after a short or long interruption. Furthermore brush cleaning often involves liquids which are not environment friendly, and therefore potentially poses a hazard, both to the person using the liquid and to the ambient environment.

In the art, a number of solutions have been proposed. For example in US 2005/0271309 is disclosed a disposable flexible container for temporary storage of a paint brush. The disposable flexible container is designed to store the entire paint brush without interfering with the bristles of the paint brush. The container is provided with a closing flap and a weakened line such that when it is desirable to withdraw the used paint brush from the container, the disposable container can be torn at the weakened line in order to gain access to the paint brush.

This container works on the principle that by folding the closing flap the disposable container is closed around the paint brush such that evaporation and other exchange with the ambient environment is hindered. Due to the volume inside the flexible container a certain amount of particularly oxygen is available for the remaining paint in the bristles of the brush such that a certain hardening of the remaining paint on the bristles will occur and thereby diminish the quality of the bristles when they are to be used again after the brush has been stored in the disposable container.

A further storage container working with the same principle as described above is disclosed in GB 2514381. In this paint brush cleaner bag it is foreseen that the interior of the cleaner bag shall be filled with a liquid, for example water, in order to stop the hardening process of the paint in the bristles of the brush.

Furthermore, for water soluble paints it is foreseen with this invention that the bristles are cleaned during storage such that a fresh, clean brush is available after having been stored in the paint brush cleaner according to GB 2514381.

From U.S. Pat. No. 6,050,408 and US 2014/0144979 rigid paint brush holders/storage devices are known. Common for these two examples is the fact that they comprise rigid containers having removable lids such that after the paint brush has been inserted into the rigid container, the lid is added isolating the paint brush from the ambient environment.

The rigid paint brush holders/storage devices may furthermore be at least partly filled with a liquid in order to minimize evaporation and maintain the bristles in a fresh condition.

Common for all the devices above is the fact that they do not effectively hinder the hardening of paint residues between the bristles of the paint brush and furthermore they all have rather complicated and expensive constructions which when used in significant numbers cause an extra cost to the paint job.

### OBJECT OF THE INVENTION

The objective of the present invention is therefor to provide an inexpensive device that will make the cleaning of the brush unnecessary and still maintain the good quality of the paint job even after a while.

### DESCRIPTION OF THE INVENTION

The objective of the present invention is achieved through a storage device for a brush, the storage device comprising a flexible plastic container comprising an inside face and an outside face, where the plastic container comprises a tapered area between a first wider end towards a second narrower end and where the tapered area on the inside face has a dimension allowing a fit with one or more sizes of brush heads.

The tapering of the storage device means that the storage device may fit tight, essentially airtight with the brush head, while leaving only a limited amount of air below the contact area between the storage device and the brush head.

In further embodiments two or more tapered areas are provided with different dimensions between the first end and the second end, or where the tapering is nonlinear between the first end and the second end.

Preferably a more rigid material is provided at the first end of the storage device, e.g. at least partly or wholly along the circumference of the first end. This allows for an improved handling of the storage device, where the insertion of the brush in particular is facilitated.

Advantageously a tearing line is provided in the storage device allowing separation of the storage device between the first end and the second end. This will allow for an easier removal of the storage device when the brush is intended to be used again. The tearing line may comprise a weakened material area, e.g. through laser cutting some of the layers pf a plastics sheet.

Preferably the storage device is manufactured from a material capable of resisting influence of chemicals present in paint. Various types of paint and other substances require different materials. When used in connection with a paint brush, the storage device may require the use of materials resistant to various solvents.

Advantageously fixation means are provided on the storage device, e.g. in the form of a hook for hanging the storage device or double acting tape for attaching the storage device to a paint container or the like. This will facilitate managing the relationship between different brushes and paint containers.

Advantageously the flexible material has properties allowing a snug fit with the brush head and providing a frictional resistance against movement of the brush head.

Preferably where the tapering angle α is between 10 degrees and 40 degrees.

The objective of the invention is further achieved through a set of storage containers according to claim 10, where different sizes of storage devices are provided, adapted to use with different brush sizes. During a paint job the use of different sizes of brushes is often necessary and in order to maintain the brushes ready and operable with no hardened or dried paint, a selection of different sizes of storage devices is relevant.

Preferably different sizes of storage devices are provided, adapted to use with different brush sizes and where a size indication is provided on each size of storage device, e.g. where each size of storage device has a dedicated colour coding.

The invention will be described in further detail in the following detailed description of preferred embodiments, with reference to the attached drawing, where:

### DESCRIPTION OF THE DRAWING

FIG. 1A-1B show a first embodiment of the storage device;

FIG. 2A-2B show a second embodiment of the storage device;

FIG. 3A-3B show a third embodiment of the storage device;

FIG. 4 shows an embodiment where a weakening line is provided;

FIG. 5 shows the tapering angle of the storage device;

FIG. 6A-6B show embodiments comprising a holding device;

FIG. 7A-7B show the embodiments of FIG. 6 where a brush has been inserted into the device; and

FIG. 8A-8D show various details of a possible production configuration.

### DETAILED DESCRIPTION OF THE INVENTION

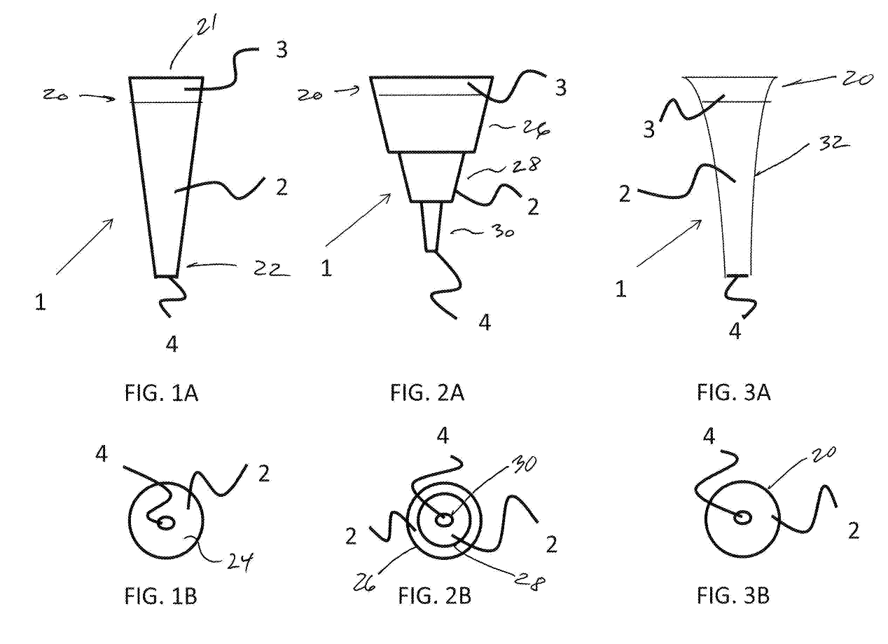

FIG. 1 shows a first embodiment of the storage device 1 according to the invention. FIG. 1A shows the storage device seen in a side view and FIG. 1B shows the storage device in a top view. The storage device comprises a tapered plastic container 2, surrounding a cavity 24 (see FIG. 1b) where the tapering is linear. The cavity 24 has an open upper end 21 and a closed lower end area 4. At a first end 20 the storage device is wider and at a second end 22 the storage device is narrower. The second end 22 is shown with a cut off end area 4, which may reduce the amount of air trapped in the storage device when inserting a brush into the cavity 24 formed inside the storage device. This also accounts for the further embodiments shown. At the wider first end 20 the storage device comprises a stabilizing part 3, which may be a more rigid plastics part welded or adhered to the container. The more rigid part 3 may be extending wholly or partly along the circumference of the storage device. It shall be understood that the device functions also without the more rigid part, but tests indicate that it is easier to open the storage device in order to gain access to the cavity 24, when a more rigid section is provided adjacent the top end 20.

FIG. 2 shows a second embodiment of the storage device 1 according to the invention. FIG. 2A shows the storage device seen in a side view and FIG. 2B shows the storage device in a top view. The storage device comprises a tapered plastic container 2, where the tapering is stepwise linear in subsequent parts 26,28,30 of the storage device. For each part is the upper opening larger than the lower opening. In this manner the storage device in this embodiment is suitable for storing brushes having three different sizes of brushes (depending on the size of their bristle holder). Each part 26,28,30 will due to the taper accommodate a number of sizes having more or less the same size. At the wider first end the storage device comprises a stabilizing part 3, which may be a more rigid plastics part that is welded to the container. The more rigid part 3 may be extending wholly or partly along the circumference of the storage device.

FIG. 3 shows a third embodiment of the storage device 1 according to the invention. FIG. 3A shows the storage device seen in a side view and FIG. 3B shows the storage device in a top view. The storage device comprises a tapered plastic container 2, where the tapering 32 is non-linear, i.e. the profile of the storage device has a curvature where the decrease in inner cross section area (the cavity's cross-sectional area) is larger at the first end 20 than at the second end 4. At a first end 20 the storage device is wider and at a second end 4 the storage device is narrower. At the wider first end the storage device comprises a stabilizing part 3, which may be a more rigid plastics part that is welded to the container.

By providing a curved taper, the storage device is more “universal” in that it may accommodate a wide selection of brushes, and still provide the desired effect. The more rigid part may be extending wholly or partly along the circumference of the storage device.

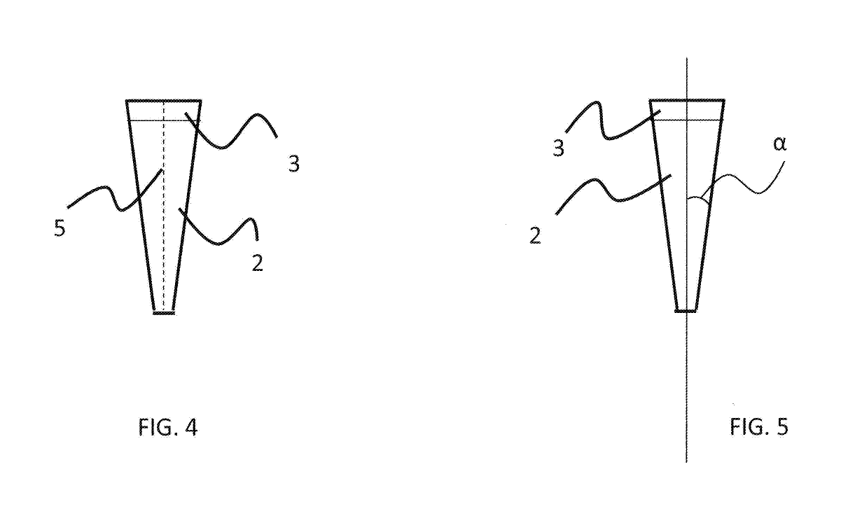

FIG. 4 shows one embodiment of the storage device, where a weakening line/tearing line 5 is indicated with a dotted line. The weakening line 5 serves the purpose of allowing removal of the storage device from the brush by tearing at the weakening line and unwrapping the storage device. This facilitates the removal of the storage device.

The weakening line may obviously be part of any embodiment of the storage device. The weakening line may be formed through any process, where this preferably is a weakening line not penetrating the plastic layer. The weakening line may be made by laser scoring or like technologies.

FIG. 5 shows an embodiment of a storage device, where the tapering angle is indicated as the angle α between an axis through the centre of the storage device and extending from the first end to the second end and the outer periphery of the storage device. Where a stepwise tapering is provided the angle is measured at the tapered portion and where a non-linear, continuous or stepwise, tapering is provided the angle is measured at a particular point of the surface of the storage device.

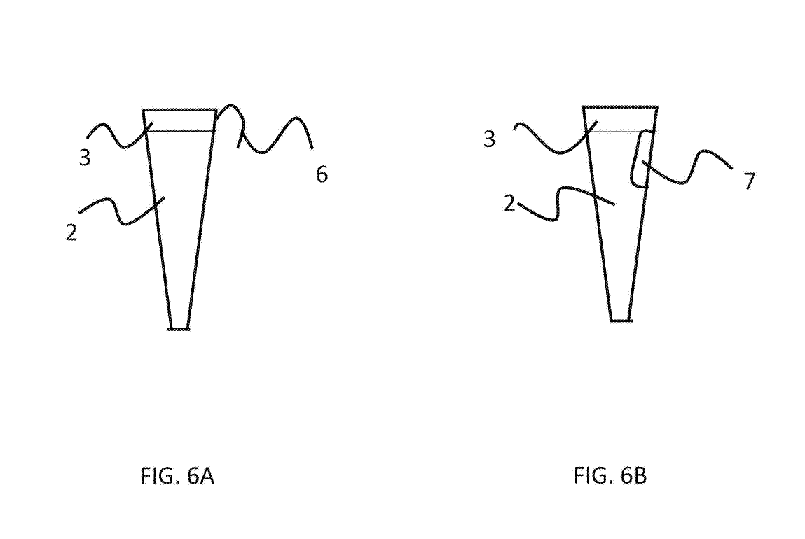

FIG. 6 shows embodiments of the storage device with holding devices provided at the surface of the storage device. FIG. 6A shows an embodiment where a hook 6, preferably a plastics hook, attached to the outer surface of the storage device. The hook serves the purpose of hanging the storage device on a paint container or the like. When hanging on a paint container the relationship between the paint and the brush is easier manageable. FIG. 6B shows an embodiment of the storage device, where double action adhesive tape 7 is used as a holding device. An adhesive tape or various types of releasable adhesives may in addition to the easier manageable relationship between brush and paint provide the safety of maintaining the position storage device in a more firm manner.

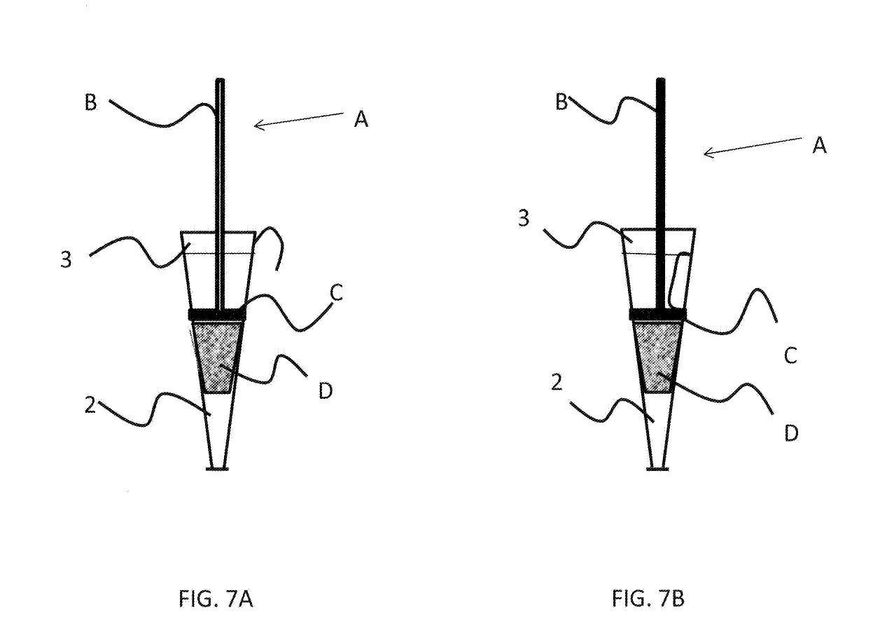

In FIGS. 7A and 7B the same embodiments as shown in FIGS. 6A and 6B are depicted with paint brush A inserted into the storage device. Such brush normally comprises a handle B, a brush head C with hair/bristles D. The inside surface of the storage device will fit tight towards the circumferential surface/periphery of the brush head C and the brush hair D will be forced slightly towards each other due to the tapering of the storage device 1.

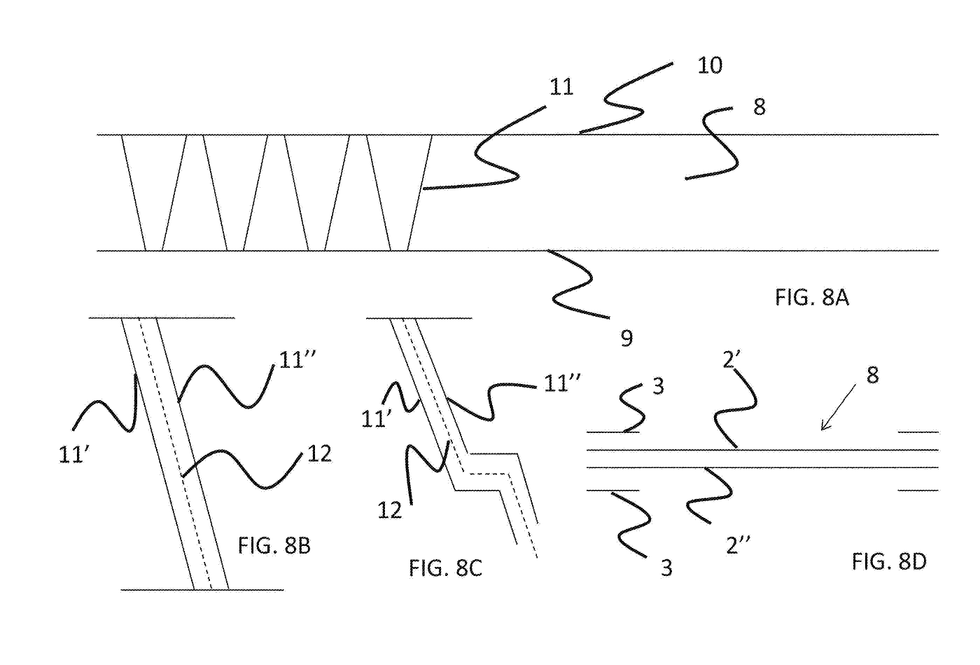

In FIG. 8 a continuous series 8 of storage devices is shown. By providing two sheets of plastics material 2′,2″ and possibly reinforcement areas 3 at the outer areas 10 of the sheets 2 on top of each other, the layers may be welded together. The welding area 11 preferably comprises two welding lines 11′,11″ and a separation line 12 between these. The separation line may be a simple perforation line. The welding lines and separation lines may be linear as shown in FIG. 8B or partly linear as shown in FIG. 8C. Other shapes of welding lines are also possible, such as curved which will provide storage devices as illustrated in FIG. 3a.

The reinforcement 3 illustrated in a number of the embodiments is not mandatory. The invention performs almost equally well without this rigid portion 3. It is clear that the extra production step of providing the rigid section makes the storage device more expensive. The storage device is hence also contemplated without the rigid section. It is furthermore clear that a skilled person will select the material from which to manufacture the storage device with due respect to the manufacturing process (for example use a plastic film comprising a weldable layer if the storage devices are to be manufactured in a process involving welding). The same is true with respect to the types of paint that are usuable with the storage device. For some paints special chemical resistant layers shall be provided in the plastic film.

1. A storage device for a brush, the storage device comprising a flexible plastic container having an inner cavity delimited by flexible plastic film comprising an inside face and an outside face, where the inner cavity of the plastic container comprises a tapered section between a first wider open end towards a second narrower closed end, and where the tapered section on the inside face has a dimension which in use allows a fit with one or more different sizes of brush heads.

2. The storage device according to claim 1, where two or more tapered sections are provided, each tapered section having different dimensions between the first end and the second end, or where the tapering is nonlinear between the first end and the second end.

3. The storage device according to claim 1, where a more rigid material is provided at the first end of the storage device, e.g. at least partly or wholly along the circumference of the first end.

4. The storage device according to claim 1, where a tearing line is provided in the storage device allowing separation of the storage device between the first end and the second end.

5. The storage device according to claim 1, where the storage device is manufactured from a solvent and chemically resistant material.

6. The storage device according to claim 1, where means are provided on the storage device, for hanging or attaching the storage device to a further object.

7. The storage device according to claim 1, where the flexible plastic film has properties allowing a snug fit with the brush head and providing a frictional resistance against movement of the brush head.

8. The storage device according to claim 1, where the tapering angle α is between 10 degrees and 40 degrees.

9. A set of storage devices comprising a plurality of storage devices according to claim 1, where the storage devices of different sizes of are adapted to use with different brush sizes and where a size indication is provided on each storage device.

10. A set of storage devices according to claim 9, where the size indication may be a number, a colour or a sign.

11. Method of using a storage device for a used paint brush, the storage device comprising a flexible plastic container having an inner cavity delimited by flexible plastic film comprising an inside face and an outside face, where the inner cavity of the plastic container comprises a tapered section between a first wider open end towards a second narrower closed end, and where the tapered section on the inside face has a dimension which in use allows a fit with one or more different sizes of brush heads, wherein a storage device of an appropriate size is selected, and thereafter at least the brush bristles of the used brush are inserted into the cavity, such that the tapered section squeezes or urges the brush bristles together, thereby expelling excess paint and air.

12. Method according to claim 11, wherein the storage device is provided with a tearing line allowing separation of the storage device between the first end and the second end, such that when the brush is to be used again, either the storage device is separated in two along the tearing line, thereby exposing the brush bristles, or the brush is withdrawn from the cavity.

13. Use of the storage device according to claim 1.

14. Use of the storage device in a method according to claim 12.

15. Use of a storage device for a used paint brush, the storage device comprising a flexible plastic container having an inner cavity delimited by flexible plastic film comprising an inside face and an outside face, where the inner cavity of the plastic container comprises a tapered section between a first wider open end towards a second narrower closed end, and where the tapered section on the inside face has a dimension which in use allows a fit with one or more different sizes of paint brush heads such that ambient air is not allowed to interact with paint residue left in the bristles of the used paint brush.
